(19) United States
(12) Patent Application Publication
(10) Pub. No.: US 2013/0346890 A1
(43) Pub. Date: Dec. 26, 2013

(54) INTERFACE AUTONOMOUS PLANNING METHOD AND APPARATUS

(71) Applicant: Huawei Device Co., Ltd., Shenzhen (CN)

(72) Inventor: Mingxiu ZHANG, Beijing (CN)

(73) Assignee: Huawei Device Co., Ltd., Shenzhen (CN)

(21) Appl. No.: 14/010,135

(22) Filed: Aug. 26, 2013

Related U.S. Application Data
(63) Continuation of application No. PCT/CN2012/071741, filed on Feb. 28, 2012.

(30) Foreign Application Priority Data
Feb. 28, 2011 (CN) 201110047434.3

(51) Int. Cl. G06F 3/048

(52) U.S. Cl. CPC G06F 3/048
USPC 715/762

(57) ABSTRACT

The present disclosure provides an interface autonomous planning method and apparatus. The interface autonomous planning method includes: dividing, according to an interface layout request, an interface into regions, the number of which is the same as the number of interface element types in the interface layout request, where the interface layout request includes the number of interface element types; dividing each region into a text block and an element block; and arranging, according to an interface element division request, each interface element to an element block of a region corresponding to an interface element type of the interface element, and displaying, in a text block of each region, an interface element type corresponding to the region, where the interface element division request includes interface element types of interface elements and interface element types corresponding to the regions.

### CROSS-REFERENCE TO RELATED APPLICATIONS

This application is a continuation of International Patent Application No. PCT/CN2012/071741, filed on Feb. 28, 2012, which claims priority to Chinese Patent Application No. 201110047434.3, filed on Feb. 28, 2011, both of which are hereby incorporated by reference in their entireties.

### TECHNICAL FIELD

Embodiments of the present disclosure relate to computer technologies, and in particular, to interface autonomous planning methods and apparatus.

### BACKGROUND

At present, an interface element layout method used for interfaces of various terminals such as the interface of a mobile phone, the interface of a personal digital assistant, the interface of a palmtop computer, and the interface of a personal computer includes: enumerating all interface elements on an interface in a set arrangement mode, or dividing interface elements into the fixed number of types, and arranging the interface elements into different regions of the interface according to the types.

However, this interface layout method is fixed for a user. The user is unable to lay out each interface element on the interface according to a preference.

### SUMMARY

Embodiments of the present disclosure provide interface autonomous planning methods and apparatus to overcome the disadvantage that a user cannot autonomously select an interface layout in the prior art and to achieve the objective of laying out an interface according to the user's preference.

An embodiment of the present disclosure provides an interface autonomous planning method, including:

dividing, according to an interface layout request, an interface into regions, the number of which is the same as the number of interface element types in the interface layout request, where the interface layout request includes the number of interface element types;

dividing each region into a text block and an element block; and

arranging, according to an interface element division request, each interface element to an element block of a region corresponding to an interface element type of the interface element, and displaying, in a text block of each region, an interface element type corresponding to the region, where the interface element division request includes interface element types of interface elements and interface element types corresponding to the regions.

An embodiment of the present disclosure provides an interface autonomous planning apparatus, including:

a receiving module, configured to: receive an interface layout request, where the interface layout request includes the number of interface element types; and further configured to receive an interface element division request, where the interface element division request includes interface element types of interface elements and interface element types corresponding to regions;

a region dividing module, configured to divide, according to the interface layout request, an interface into regions, the number of which is the same as the number of interface element types;

a block dividing module, configured to divide each region into a text block and an element block; and

an arranging module, configured to arrange, according to the interface element division request, each interface element to an element block of a region corresponding to an interface element type of the interface element, and display, in a text block of each region, an interface element type corresponding to the region.

With the interface autonomous planning method and apparatus provided by the embodiments of the present disclosure, a terminal divides an interface into the corresponding number of regions according to the number of interface element types selected by a user, where the layout of regions is based on a preset region layout mode, and divides each region into a text block for displaying an interface element type and an element block for arranging interface elements. Therefore, the terminal may provide interfaces with different layouts for the user according to the autonomous selection of the user. Each region has display information indicating an interface element type, and an interface element in each region may also be drawn according to the autonomous selection of the terminal. Therefore, the embodiments of the present disclosure achieve the objective of laying out an interface according to the user's preference.

An embodiment of the present disclosure further provides an interface autonomous planning method, including:

dividing an interface into 2*N blocks according to the number of interface element types in an interface division request, where N is the number of interface element types, and the interface division request includes the number of interface element types, display positions of the interface element types, each interface element type, and an interface element type of each interface element;

when the display positions of the interface element types indicate that the interface element types are displayed in a row, setting all blocks in a first row as text blocks, displaying an interface element type in each text block, setting all blocks in a second row as element blocks, and drawing, in each element block, an interface element corresponding to an interface element type displayed in a text block in a same column;

when the display positions of the interface element types indicate that the interface element types are displayed in a column, setting all blocks in a first column as text blocks, displaying an interface element type in each text block, setting all blocks in a second column as element blocks, and drawing, in each element block, an interface element corresponding to an interface element type displayed in a text block in a same row.

An embodiment of the present disclosure further provides an interface autonomous planning apparatus, including:

a dividing module, configured to divide an interface into 2*N blocks according to the number of interface element types in an interface division request, where N is the number of interface element types, and the interface division request includes the number of interface element types, display positions of the interface element types, each interface element type, and an interface element type of each interface element;

a first drawing module, configured to: when the display positions of the interface element types indicate that the interface element types are displayed in a row, set all blocks in a first row as text blocks, display an interface element type in each text block, set all blocks in a second row as element blocks, and draw, in each element block, an interface element corresponding to an interface element type displayed in a text block in a same column;

a second drawing module, configured to: when the display positions of the interface element types indicate that the interface element types are displayed in a column, set all blocks in a first column as text blocks, display an interface element type in each text block, set all blocks in a second column as element blocks, and draw, in each element block, an interface element corresponding to an interface element type displayed in a text block in a same row.

With the interface autonomous planning method and apparatus provided by the embodiments of the present disclosure, a terminal divides, according to the number of interface element types selected by a user, an interface into blocks, the number of which is twice the number of interface element types, and according to the display positions of the interface element types selected by the user, displays the interface element types in all blocks of the first row or first column, and displays, in an adjacent block in the second row or an adjacent block in the second column, all interface elements of an interface element type corresponding to a block in the same column or same row. Therefore, the terminal may provide interfaces with different layouts for the user according to the autonomous selection of the user, set a block where each interface element is located, and set an interface element type of each interface element. Therefore, the objective of laying out an interface according to the user's preference is achieved.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and persons of ordinary skill in the art may still derive other drawings from these accompanying drawings without creative efforts.

FIG. 1A is a flowchart of an interface autonomous planning method according to an embodiment of the present disclosure;

FIG. 1B is an interface layout mode diagram of an interface autonomous planning method according to an embodiment of the present disclosure;

FIG. 1C is another interface layout mode diagram of an interface autonomous planning method according to an embodiment of the present disclosure;

FIG. 1D is still another interface layout mode diagram of an interface autonomous planning method according to an embodiment of the present disclosure;

FIG. 1E is still another interface layout mode diagram of an interface autonomous planning method according to an embodiment of the present disclosure;

FIG. 1F is still another interface layout mode diagram of an interface autonomous planning method according to an embodiment of the present disclosure;

FIG. 1G is still another interface layout mode diagram of an interface autonomous planning method according to an embodiment of the present disclosure;

FIG. 2 is a schematic structural diagram of an interface autonomous planning apparatus according to a first embodiment of the present disclosure;

FIG. 3A is a schematic structural diagram of an interface autonomous planning apparatus according to a second embodiment of the present disclosure;

FIG. 3B is a schematic structural diagram of an interface autonomous planning apparatus according to a third embodiment of the present disclosure;

FIG. 4A is a flowchart of another interface autonomous planning method according to an embodiment of the present disclosure;

FIG. 4B is an interface layout mode diagram of another interface autonomous planning method according to an embodiment of the present disclosure;

FIG. 4C is another interface layout mode diagram of another interface autonomous planning method according to an embodiment of the present disclosure; and

FIG. 5 is a schematic structural diagram of another interface autonomous planning apparatus according to an embodiment of the present disclosure.

### DESCRIPTION OF EMBODIMENTS

To make the objectives, technical solutions, and advantages of the embodiments of the present disclosure more comprehensible, the following clearly describes the technical solutions in the embodiments of the present disclosure with reference to the accompanying drawings in the embodiments of the present disclosure. The described embodiments are merely a part rather than all of the embodiments of the present disclosure. All other embodiments obtained by persons of ordinary skill in the art based on the embodiments of the present disclosure without creative efforts shall fall within the protection scope of the present disclosure.

The interface autonomous planning method provided by the present disclosure allows a user to select an interface layout mode. The interface layout mode selected by the user is received and an interface with laid out application icons is presented to the user according to the interface layout mode autonomously selected by the user.

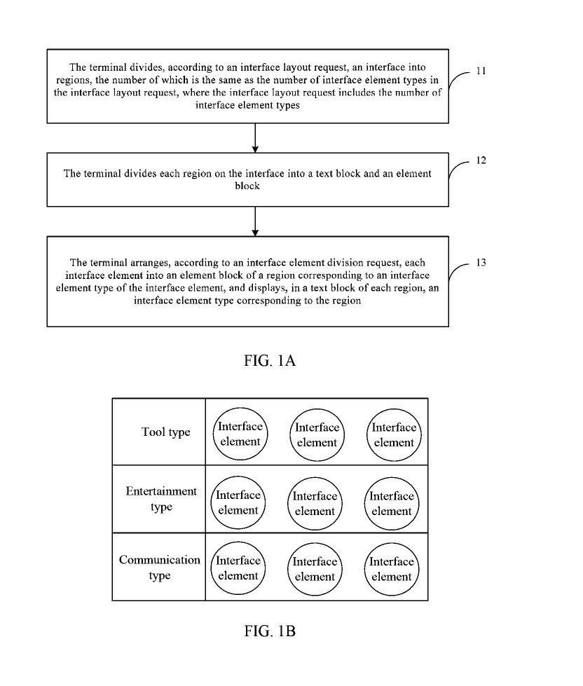

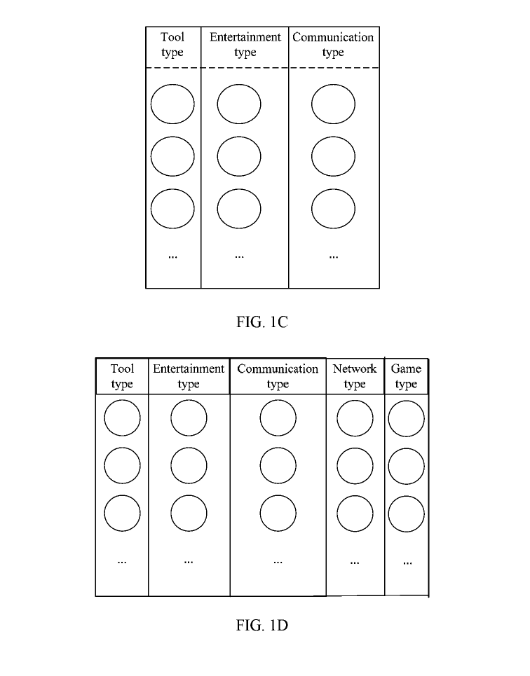

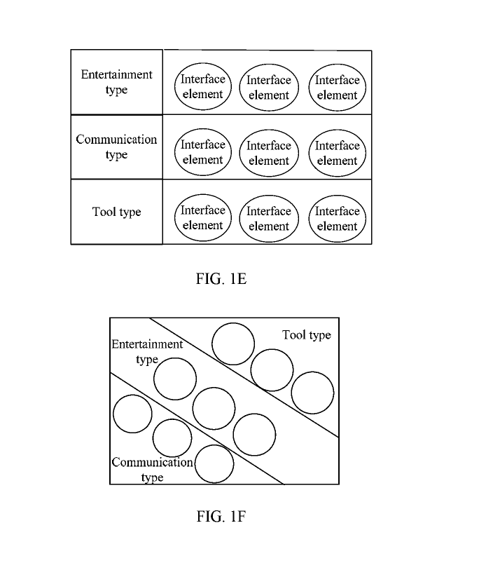

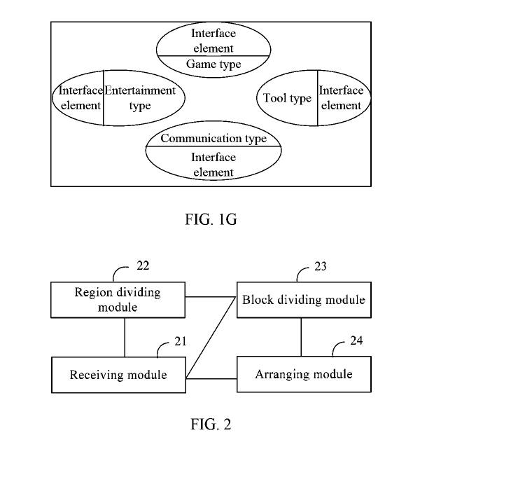

FIG. 1A is a flowchart of an interface autonomous planning method according to an embodiment of the present disclosure. FIG. 1B is an interface layout mode diagram of an interface autonomous planning method according to an embodiment of the present disclosure. FIG. 1C is another interface layout mode diagram of an interface autonomous planning method according to an embodiment of the present disclosure. FIG. 1D is still another interface layout mode diagram of an interface autonomous planning method according to an embodiment of the present disclosure. FIG. 1E is still another interface layout mode diagram of an interface autonomous planning method according to an embodiment of the present disclosure. FIG. 1F is still another interface layout mode diagram of an interface autonomous planning method according to an embodiment of the present disclosure. FIG. 1G is still another interface layout mode diagram of an interface autonomous planning method according to an embodiment of the present disclosure.

The executing entity in this embodiment may be a terminal or a central processing unit of the terminal. As shown in FIG. 1A, this embodiment includes:

Step 11: The terminal divides, according to an interface layout request, an interface into regions, the number of which is the same as the number of interface element types in the interface layout request, where the interface layout request includes the number of interface element types.

In the embodiment of the present disclosure, the terminal provides the user with a man-machine interface for inputting or selecting the number of interface element types. The terminal receives the interface layout request of the user through the man-machine interface, where the interface layout request includes the number of interface element types requested by the user. The number of interface element types is abbreviated as an interface element type quantity, and is the number of types of all interface elements divided by the user. In the embodiment of the present disclosure, interface elements of a type are drawn in a region. Therefore, the number of interface element types is also the number of regions obtained by dividing the interface.

After receiving the interface layout request of the user, the terminal divides, according to the number of interface element types and a preset region layout mode, the interface into regions, the number of which is the same as the number of interface element types. For example, the user selects to divide all interface elements into three types, that is, the number of interface element types is three; as shown in FIG. 1B, after receiving the interface layout request of the user, the terminal divides the regions on the interface into three regions according to the interface layout request, where the regions are arranged according to the region layout mode preset by the terminal. The arrangement in a default region layout mode is that each region is in a rectangular shape and occupies a row of the interface.

The region layout mode may be preset by the terminal or set by the user. Further, the terminal provides the user with a man-machine interface for inputting or selecting a region layout mode. The region layout mode is a region arrangement mode, for example, regions are arranged by columns, regions are arranged by rows, or regions are arranged together to form a diamond. After receiving the interface layout request of the user, the terminal divides, according to the region layout mode, the interface into regions, the number of which is the same as the number of interface element types.

For example, the user selects to divide all interface elements into three types, that is, the number of interface elements is three, and the user selects to arrange regions by rows, that is, the region layout mode is that regions are arranged by rows. As shown in FIG. 1B, after receiving the interface layout request of the user, the terminal divides the regions on the interface into three regions according to the interface layout request, and each region is in a rectangular shape and occupies a row of the interface.

As another example, the user selects to divide all interface elements into three types, and the user selects to arrange regions by columns, that is, the region layout mode is that regions are arranged by columns. As shown in FIG. 1C, after receiving the interface layout request of the user, the terminal also divides the interface into three regions, and each region is also in a rectangular shape, but the interface layout mode is different from that of FIG. 1B, and each region on the interface occupies a column of the interface, that is, regions are arranged by columns. For another example, the user selects to divide all interface elements into five types, and the user also selects to arrange regions by columns. As shown in FIG. 1D, after receiving the interface layout request of the user, the terminal divides the interface into five regions. The region layout mode is the same as the region layout mode shown in FIG. 1C, but the number of regions on the interface is different from that in FIG. 1C. For another example, the user selects to divide all interface elements into five types, and the user selects to arrange the regions by diagonals. As shown in FIG. 1F, the terminal divides the regions on the interface into three regions according to the interface layout request, and the regions are arranged by diagonals. For another example, the user selects to divide all interface elements into four types, and the user selects to arrange the regions to form a diamond. As shown in FIG. 1G, the terminal divides the regions on the interface into four regions according to the interface layout request, and the regions are arranged to form a diamond.

Further, a shape and size of each region on the interface may be preset by the terminal, or selected by the user autonomously. When the user autonomously determines a shape and size of each region, the user inputs or selects a shape and size of each region through the man-machine interface provided by the terminal, that is, the interface layout request of the user further includes a size and shape of each region requested by the user. The terminal sets a shape and size of each region on the interface according to the shape and size of each region selected by the user. As shown in FIG. 1B to FIG. 1G, the shape of the region may be a rectangle, a circle, a triangle, or the like.

Step 12: The terminal divides each region on the interface into a text block and an element block.

The terminal divides each region on the interface into two blocks: a text block and an element block. The text block is used to display an interface element type corresponding to the region, and the element block is used to draw all interface elements of the interface element type corresponding to the region. An interface element may be an icon, and an interface element type may be text information indicating the interface element type.

Further, a shape, position, and size of each block may be preset by the terminal or autonomously selected by the user. When the user autonomously selects a shape, position, and block size of each block, the user selects a block shape, block position, and block size through the man-machine interface provided by the terminal. After receiving a block layout request, the terminal divides each region into two blocks according to the block shape, block position, and block size selected by the user, and sets one of the blocks as a text block and the other block as an element block according to a block attribute in the block layout request.

Step 13: The terminal arranges, according to an interface element division request, each interface element to the element block of the region corresponding to an interface element type of the interface element, and displays, in a text block of each region, the interface element type corresponding to the region.

The user selects an interface element type corresponding to each region through the man-machine interface, and sets an interface element type for each interface element. That is, the interface element division request received by the terminal includes an interface element type of an interface element and an interface element type corresponding to the region. As shown in FIG. 1B, an interface element type displayed in a text block of a corresponding region in a first row is “tool type”, and correspondingly, what is drawn in an element block of the corresponding region in the first row is an interface element which is obtained by autonomous dividing performed by the user and belongs to the tool type, for example, a notebook, an alarm clock or the like. An interface element type displayed in a text block of a corresponding region in a second row is “entertainment type”, and correspondingly, what is drawn in an element block of the corresponding region in the second row is an interface element which is defined by the user and belongs to the entertainment type, for example, a multimedia player, chatting software or the like. The number of regions and the region layout mode in FIG. 1E are the same as those in FIG. 1B, but an interface element drawn in an element block in each region in FIG. 1E is different from that in FIG. 1B. The above differences are all set according to different selection of the user.

In addition, before arranging an interface element to an element block, the terminal may set an icon and a shape of the interface element according to the icon and shape of the interface element in the interface element division request. Specifically, the user sets an icon and a shape of each interface element through the man-machine interface; before the terminal arranges each interface element to an element block of a region corresponding to an interface element type of the interface element, the terminal sets an icon and a shape of the interface element according to the icon and shape of the interface element set by the user.

The specific method for the terminal to arrange interface elements to element blocks and display the corresponding interface element types in the regions may be implemented by using the following two manner:

One manner is: Through the man-machine interface, the user uniformly sets interface element types for all interface elements, and uniformly sets corresponding interface element types for all regions. That is, a first interface element division request received by the terminal includes an interface element type of each interface element and an interface element type corresponding to each region. After receiving the first interface element division request, the terminal arranges each interface element to an element block of a corresponding region according to information in the first interface element division request, and after displaying an interface element type in a text block of each region, displays a final interface layout to the user.

For example, the terminal provides a layout setting list for the user through a man-machine interface. In the list, each interface element corresponds to an entry, and each region corresponds to an entry. An entry corresponding to an interface element provides the user with a selection button for setting an interface element type corresponding to the interface element, and an entry corresponding to a region provides the user with an input box for setting an interface element type corresponding to the region. After receiving the layout list, the terminal arranges each interface element to a corresponding region according to the information in the list, and after displaying an interface element type in each region, displays an interface layout to the user.

Another manner is: The user inputs, in a text block of each region, an interface element type corresponding to the region through the man-machine interface, and drags each interface element to an element block of a corresponding region. That is, the terminal firstly receives second interface element division requests one by one, where a second interface element division request includes an interface element type corresponding to a region. The terminal sets, in a text block of each region, an interface element type of each region according to the second interface element division requests in sequence. Afterward, the terminal receives third interface element division requests one by one, where a third interface division request includes an interface element type of an interface element. The terminal arranges, according to the third interface element division requests in sequence, each interface element to an element block of a region corresponding to an interface element type of the interface element.

With the interface autonomous planning method provided by the embodiment of the present disclosure, the terminal divides an interface into the corresponding number of regions according to the number of interface element types selected by the user, where the layout of regions is based on a preset region layout mode or a region layout mode set by the user, and divides each region into a text block for displaying an interface element type and an element block for arranging interface elements. Therefore, the terminal may provide interfaces with different layouts for the user according to the autonomous selection of the user. Each region has display information indicating an interface element type, and an interface element in each region may also be drawn according to the autonomous selection of the terminal. Therefore, the embodiment of the present disclosure achieves the objective of laying out an interface according to the user's preference.

FIG. 2 is a schematic structural diagram of an interface autonomous planning apparatus according to a first embodiment of the present disclosure. As shown in FIG. 2, this embodiment includes a receiving module 21, a region dividing module 22, a block dividing module 23, and an arranging module 24.

The receiving module 21 is configured to: receive an interface layout request, where the interface layout request includes the number of interface element types; and further configured to receive an interface element division request, where the interface element division request includes interface element types of interface elements and interface element types corresponding to regions.

The region dividing module 22 is configured to divide, according to the interface layout request received by the receiving module 21, an interface into regions, the number of which is the same as the number of interface element types. Further, the interface layout request includes a region layout mode. The region dividing module 22 is specifically configured to arrange the regions according to the region layout mode.

Further, the interface layout request includes a region shape and a region size. The region dividing module 22 is further configured to determine a shape and size of each region on the interface according to the region shape and region size in the interface layout request.

The block dividing module 23 is configured to divide each region, obtained by the dividing performed by the region dividing module 22, into a text block and an element block. Further, the block dividing module 23 is specifically configured to divide each region into two blocks according to a block shape, block position, and block size in a block layout request received by the receiving module 21, and set one of the blocks as a text block and the other block as an element block according to a block attribute in the block layout request.

The arranging module 24 is configured to arrange, according to the interface element division request, each interface element to an element block of a region corresponding to an interface element type of the interface element, and display, in a text block of each region, an interface element type corresponding to the region, where the interface element division request includes interface element types of interface elements and interface element types corresponding to the regions. Further, the arranging module 24 is configured to set, according to the icon and shape of an interface element, the icon and shape of the interface element, where the interface element division request further includes the icon and shape of the interface element.

The working mechanism of each module above is described in the embodiment corresponding to FIG. 1A, and is not further described herein.

In this embodiment of the present disclosure, the terminal divides an interface into the corresponding number of regions according to the number of interface element types selected by a user, where the layout of regions is based on a preset region layout mode or a region layout mode set by the user, and divides each region into a text block for displaying an interface element type and an element block for arranging interface elements. Therefore, the terminal may provide interfaces with different layouts for the user according to the autonomous selection of the user. Each region has display information indicating an interface element type, and an interface element in each region may also be drawn according to the autonomous selection of the terminal. Therefore, this embodiment of the present disclosure achieves the objective of laying out an interface according to the user's preference.

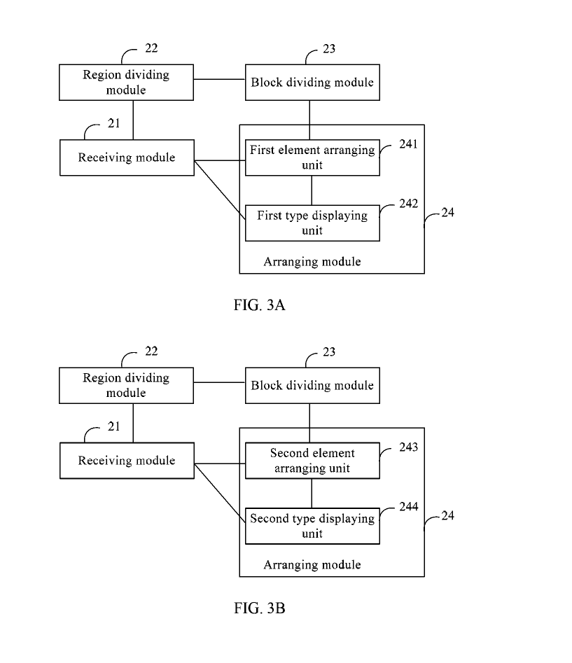

FIG. 3A is a schematic structural diagram of an interface autonomous planning apparatus according to a second embodiment of the present disclosure. As shown in FIG. 3A, an arranging module 24 includes: a first element arranging unit 241 and a first type displaying unit 242.

The interface element division request received by a receiving module 21 includes a first interface element division request. The first interface element division request includes an interface element type of each interface element and an interface element type corresponding to each region.

The first element arranging unit 241 is configured to arrange, according to the received first interface element division request, each interface element to an element block of a region corresponding to an interface element type of the interface element.

The first type displaying unit 242 is configured to display, in a text block of each region, an interface element type corresponding to the region in the first interface element division request.

The working mechanism of each module above is described in the embodiment corresponding to FIG. 1A, and is not further described herein.

In this embodiment, a user may uniformly set interface element types for all interface elements through a man-machine interface, and uniformly set corresponding interface element types for all regions. After receiving the first interface element division request, the terminal arranges each interface element to an element block of a corresponding region according to information in the first interface element division request, and after displaying an interface element type in a text block of each region, displays a final interface layout to the user.

FIG. 3B is a schematic structural diagram of an interface autonomous planning apparatus according to a third embodiment of the present disclosure. As shown in FIG. 3B, an arranging module 24 includes: a second element arranging unit 243 and a second type displaying unit 244.

The interface element division request received by a receiving module 21 includes a second interface element division request and a third interface element division request. The second interface element division request includes an interface element type corresponding to a region, and the third interface element division request includes an interface element type of an interface element.

The second element arranging unit 243 is configured to arrange, according to third interface element division requests received in sequence, each interface element to an element block of a region corresponding to an interface element type of the interface element in sequence.

The second type displaying unit 244 is configured to display, in a text block of each region, an interface element type corresponding to the region in sequence according to second interface element division requests received in sequence.

The working mechanism of each module above is described in the embodiment corresponding to FIG. 1A, and is not further described herein.

In this embodiment, a user may input, in a text block of each region, an interface element type corresponding to the region through a man-machine interface, and drag each interface element to an element block of a corresponding region. The terminal sets, in a text block of each region, an interface element type of the region according to the second interface element division requests in sequence. Afterward, the terminal receives third interface division requests one by one, where a third interface division request includes an interface element type of an interface element. The terminal arranges, according to the third interface division requests in sequence, each interface element to an element block of a region corresponding to an interface element type of the interface element.

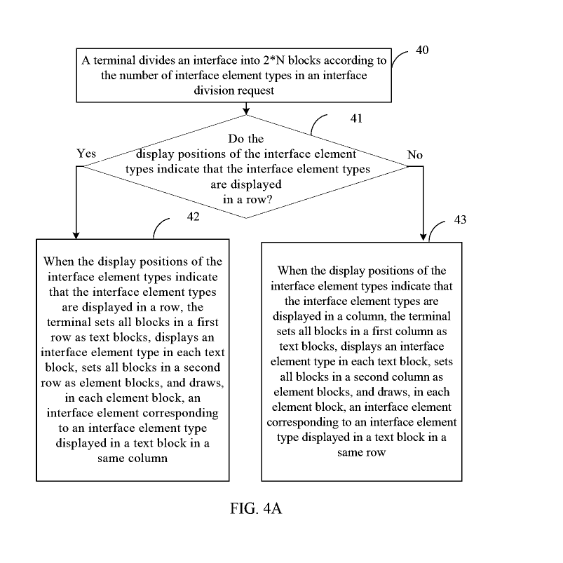

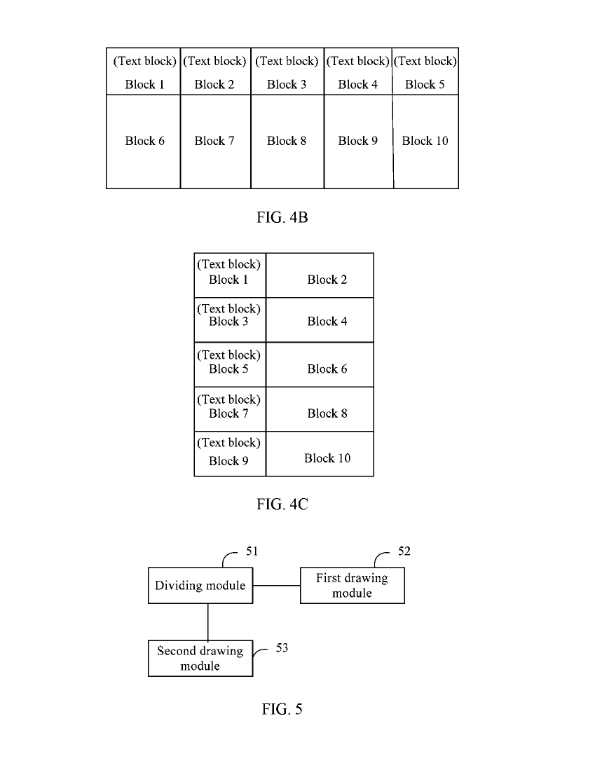

FIG. 4A is a flowchart of another interface autonomous planning method according to an embodiment of the present disclosure. As shown in FIG. 4A, this embodiment includes:

Step 40: A terminal divides an interface into 2*N blocks according to the number of interface element types in an interface division request, where N is the number of interface element types.

The terminal receives the interface division request of a user through a man-machine interface. The interface division request includes the number of interface element types, display positions of the interface element types, each interface element type, and an interface element type of each interface element which are requested by the user. The number of interface element types is abbreviated as an interface element type quantity, and is the number of types of all interface elements divided by the user. An interface element type may be text information indicating the interface element type.

Step 41: The terminal determines whether the display positions of the interface element types indicate that the interface element types are displayed in a row. If yes, the process goes to step 42; otherwise, the process goes to step 43.

Step 42: When the display positions of the interface element types indicate that the interface element types are displayed in a row, the terminal sets all blocks in a first row as text blocks, displays an interface element type in each text block, sets all blocks in a second row as element blocks, and draws, in each element block, an interface element corresponding to an interface element type displayed in a text block in a same column.

If the display positions of the interface element types requested by the user in the interface division request indicate that the interface element types are displayed in a row, that is, the interface element types are displayed in all blocks in the first row, the terminal sets all blocks in the first row as text blocks, and correspondingly sets all blocks in the second row as element blocks. A text block is used to display an interface element type corresponding to a region, and an element block is used to draw all interface elements of an interface element type corresponding to the region. An interface element may be an icon, and an interface element type may be text information indicating the interface element type.

As shown in FIG. 4B, a user selects to divide interface elements into five types and selects to display interface element types in a row, and the terminal divides the interface into 2*5 (2 rows and 5 columns) blocks after receiving the interface division request of the user. Afterward, the user selects an attribute of each block in sequence from left to right and from the top down; according to the user's selection, the terminal sets attributes of all blocks in a first row: block 1, block 2, block 3, block 4, and block 5 as text blocks, and sets attributes of all blocks in a second row: block 6, block 7, block 8, block 9, and block 10 as element blocks, where block 6, block 7, block 8, block 9, and block 10 are used for placing icons and names of interface elements corresponding to block 1, block 2, block 3, block 4, and block 5, respectively. Then, the terminal displays interface element types input by the user in the 5 text blocks, for example, a tool type, an entertainment type, a communication type, a network type, and a game type, in block 1, block 2, block 3, block 4, and block 5, respectively. Finally, the terminal displays all interface elements of an interface element type corresponding to a text block in a same column in each of block 6, block 7, block 8, block 9, and block 10.

Step 43: When the display positions of the interface element types indicate that the interface element types are displayed in a column, the terminal sets all blocks in a first column as text blocks, displays an interface element type in each text block, sets all blocks in a second column as element blocks, and draws, in each element block, an interface element corresponding to an interface element type displayed in a text block in a same row.

If the display positions of the interface element types requested by the user in the interface division request indicate that the interface element types are displayed in a column, that is, the interface element types are displayed in all blocks in the first column, the terminal sets all blocks in the first column as text blocks, and correspondingly sets all blocks in the second column as element blocks. A text block is used to display an interface element type corresponding to a region, and an element block is used to draw all interface elements of an interface element type corresponding to the region. An interface element may be an icon, and an interface element type may be text information indicating the interface element type.

As shown in FIG. 4C, the user selects to divide interface elements into five types and selects to display interface element types in a column, and the terminal divides the interface into 5*2 (5 rows and 2 columns) blocks after receiving the interface division request of the user. Afterward, the user selects an attribute of each block in sequence from left to right and from the top down; according to the user's selection, the terminal sets attributes of all blocks in a first column: block 1, block 3, block 5, block 7, and block 9 as text blocks, and sets attributes of all blocks in a second column: block 2, block 4, block 6, block 8, and block 10 as element blocks, where block 2, block 4, block 6, block 8, and block 10 are used for placing icons and names of interface elements corresponding to block 1, block 3, block 5, block 7, and block 9, respectively. Then, the terminal displays interface element types input by the user in the 5 text blocks, for example, a tool type, an entertainment type, a communication type, a network type, and a game type, in block 1, block 3, block 5, block 7, and block 9 respectively. Finally, the terminal displays all interface elements of an interface element type corresponding to a text block in a same row in each of in block 2, block 4, block 6, block 8, and block 10.

With the interface autonomous planning method provided by the embodiment of the present disclosure, the terminal divides, according to the number of interface element types selected by the user, an interface into blocks, the number of which is twice the number of interface element types, and according to the display positions of the interface element types selected by the user, displays the interface element types in all blocks of the first row or first column, and displays, in an adjacent block in the second row or an adjacent block in the second column, all interface elements of an interface element type corresponding to a block in the same column or same row. Therefore, the terminal may provide interfaces with different layouts for the user according to the autonomous selection of the user, set a block where each interface element is located, and set an interface element type of each interface element. Therefore, the objective of laying out an interface according to the user's preference is achieved.

FIG. 5 is a schematic structural diagram of another interface autonomous planning apparatus according to an embodiment of the present disclosure. As shown in FIG. 5, this embodiment includes: a dividing module 51, a first drawing module 52, and a second drawing module 53.

The dividing module 51 is configured to divide an interface into 2*N blocks according to the number of interface element types in an interface division request, where N is the number of interface element types, and the interface division request includes the number of interface element types, display positions of the interface element types, each interface element type, and an interface element type of each interface element.

The first drawing module 52 is configured to: when the display positions of the interface element types indicate that the interface element types are displayed in a row, set all blocks in a first row as text blocks, display an interface element type in each text block, set all blocks in a second row as element blocks, and draw, in each element block, an interface element corresponding to an interface element type displayed in a text block in a same column.

The second drawing module 53 is configured to: when the display positions of the interface element types indicate that the interface element types are displayed in a column, set all blocks in a first column as text blocks, display an interface element type in each text block, set all blocks in a second column as element blocks, and draw, in each element block, an interface element corresponding to an interface element type displayed in a text block in a same row.

The working mechanism of each module above is described in the embodiment corresponding to FIG. 4A, and is not further described herein.

In the embodiment of the present disclosure, the terminal divides, according to the number of interface element types selected by the user, an interface into blocks, the number of which is twice the number of interface element types, and according to the display positions of the interface element types selected by the user, displays the interface element types in all blocks of the first row or first column, and displays, in an adjacent block in the second row or an adjacent block in the second column, all interface elements of an interface element type corresponding to a block in the same column or same row. Therefore, the terminal may provide interfaces with different layouts for the user according to the autonomous selection of the user, set a block where each interface element is located, and set an interface element type of each interface element. Therefore, the objective of laying out an interface according to the user's preference is achieved.

Persons of ordinary skill in the art may understand that all or a part of the steps of the methods in the embodiments may be implemented by a program instructing relevant hardware. The program may be stored in a computer readable storage medium. When the program is run, the foregoing steps of the methods in the embodiments are performed. The storage medium may be any medium capable of storing program codes, such as a ROM, a RAM, a magnetic disk, or an optical disk.

Finally, it should be noted that the foregoing embodiments are merely intended for describing the technical solutions of the present disclosure other than limiting the present disclosure. Although the present disclosure is described in detail with reference to the foregoing embodiments, persons of ordinary skill in the art should understand that they may still make modifications to the technical solution described in the foregoing embodiments or make equivalent replacements to some technical features thereof, without departing from the idea and scope of the technical solution of the embodiments of the present disclosure.

What is claimed is:

1. An interface autonomous planning method, the method comprising:
dividing, according to an interface layout request that includes a number of interface element types, an interface into a number of regions, the number of regions being the same as the number of interface element types in the interface layout request;
dividing each region into a text block and an element block; and
arranging, according to an interface element division request that includes interface element types of interface elements and interface element types corresponding to the regions, each interface element to an element block of a region corresponding to an interface element type of the interface element, and
displaying, in a text block of each region, an interface element type corresponding to the region.

2. The interface autonomous planning method according to claim 1, wherein the interface layout request further comprises a region layout mode, and wherein the dividing an interface into a number of regions includes arranging the regions according to the region layout mode.

3. The interface autonomous planning method according to claim 1, wherein the arranging, according to the interface element division request, each interface element to an element block of a region corresponding to an interface element type of the interface element, and displaying, in a text block of each region, an interface element type corresponding to the region, comprises:
arranging, according to a received first interface element division request, each interface element to an element block of a region corresponding to an interface element type of the interface element, wherein the first interface element division request comprises an interface element type of each interface element and an interface element type corresponding to each region; and
displaying, in a text block of each region, the interface element type corresponding to the region in the first interface element division request.

4. The interface autonomous planning method according to claim 1, wherein the arranging, according to the interface element division request, each interface element to an element block of a region corresponding to an interface element type of the interface element, and displaying, in a text block of each region, an interface element type corresponding to the region, comprises:
displaying, in the text block of each region, the interface element type corresponding to the region in sequence according to second interface element division requests received in sequence, wherein each of the second interface element division requests comprises an interface element type corresponding to a region; and
arranging, according to third interface element division requests received in sequence, each interface element to an element block of a region corresponding to an interface element type of the interface element in sequence, wherein each of the third interface element division requests comprises an interface element type of an interface element.

5. The interface autonomous planning method according to claim 1, wherein the interface layout request further includes a shape and size of a region, the method further comprising, after the dividing an interface into regions:
determining a shape and size of each region on the interface according to a shape and size of the region in the interface layout request.

6. The interface autonomous planning method according to claim 5, wherein the dividing each region into a text block and an element block comprises:
dividing each region into two blocks according to a block shape, a block position, and a block size in a block layout request; and
setting one of the blocks as a text block and the other block as an element block according to a block attribute in the block layout request.

7. The interface autonomous planning method according to claim 1, wherein the interface element division request further includes an icon and a shape of the interface element, the method further comprising, before the arranging each interface element to an element block of a region corresponding to an interface element type of the interface element:
setting, according to the icon and the shape of the interface element in the interface element division request, the icon and shape of the interface element.

8. An interface autonomous planning apparatus, comprising:
a receiving module, configured to: receive an interface layout request, wherein the interface layout request comprises a number of interface element types; and further configured to receive an interface element division request, wherein the interface element division request comprises interface element types of interface elements and interface element types corresponding to the regions;
a region dividing module, configured to divide, according to the interface layout request, an interface into a number of regions, the number of regions being the same as the number of interface element types;
a block dividing module, configured to divide each region into a text block and an element block; and
an arranging module, configured to:
arrange, according to the interface element division request received by the receiving module, each interface element to an element block of a region corresponding to an interface element type of the interface element, and
display, in a text block of each region, an interface element type corresponding to the region.

9. The interface autonomous planning apparatus according to claim 8, wherein the interface layout request further comprises a region layout mode, and wherein the region dividing module is configured to arrange the regions according to the region layout mode.

10. The interface autonomous planning apparatus according to claim 8, wherein:
the arranging module comprises a first element arranging unit and a first type displaying unit;
the interface element division request comprises a first interface element division request, wherein the first interface element division request comprises an interface element type of each interface element and an interface element type corresponding to each region;
the first element arranging unit is configured to arrange, according to the received first interface element division request, each interface element to an element block of a region corresponding to an interface element type of the interface element; and
the first type displaying unit is configured to display, in a text block of each region, an interface element type corresponding to the region in the first interface element division request.

11. The interface autonomous planning apparatus according to claim 8, wherein:
the arranging module comprises a second element arranging unit and a second type displaying unit;
the interface element division request comprises a second interface element division request and a third interface element division request, wherein the second interface element division request comprises an interface element type corresponding to a region and the third interface element division request comprises an interface element type of an interface element;
the second type displaying unit is configured to display, in a text block of each region, an interface element type corresponding to the region in sequence according to second interface element division requests received in sequence; and
the second element arranging unit is configured to arrange, according to third interface element division requests received in sequence, each interface element to an element block of a region corresponding to an interface element type of the interface element in sequence.

12. The interface autonomous planning apparatus according to claim 8, wherein the interface layout request further comprises a shape and size of the region and wherein the region dividing module is further configured to determine a shape and size of each region on the interface according to the shape and size of the region in the interface layout request.

13. The interface autonomous planning apparatus according to claim 12, wherein:
the receiving module is further configured to receive a block layout request, wherein the block layout request comprises a block shape, a block position, and a block size; and
the block dividing module is configured to divide each region into two blocks according to the block shape, block position, and block size in the block layout request, and set one of the blocks as a text block and the other block as an element block according to a block attribute in the block layout request.

14. The interface autonomous planning apparatus according to claim 8, wherein the interface element division request further comprises an icon and shape of the interface element, and wherein the arranging module is further configured to set, according to the icon and the shape of the interface element in the interface element division request, the icon and shape of the interface element.

15. An interface autonomous planning method, the method comprising:
dividing an interface into 2*N blocks according to a number, N, of interface element types in an interface division request, wherein the interface division request comprises the number, N, of interface element types, display positions of the interface element types, each interface element type, and an interface element type of each interface element; and
when the display positions of the interface element types indicate that the interface element types are displayed in a row:
setting all blocks in a first row as text blocks,
displaying an interface element type in each text block,
setting all blocks in a second row as element blocks, and
drawing, in each element block, an interface element corresponding to an interface element type displayed in a text block in a same column; and
when the display positions of the interface element types indicate that the interface element types are displayed in a column:
setting all blocks in a first column as text blocks,
displaying an interface element type in each text block,
setting all blocks in a second column as element blocks, and
drawing, in each element block, an interface element corresponding to an interface element type displayed in a text block in a same row.

16. An interface autonomous planning apparatus, comprising:
a dividing module, configured to divide an interface into 2*N blocks according to the number, N, of interface element types in an interface division request, wherein the interface division request comprises the number, N, of interface element types, display positions of the interface element types, each interface element type, and an interface element type of each interface element;
a first drawing module, configured to: when the display positions of the interface element types indicate that the interface element types are displayed in a row, set all blocks in a first row as text blocks, display an interface element type in each text block, set all blocks in a second row as element blocks, and draw, in each element block, an interface element corresponding to an interface element type displayed in a text block in a same column; and
a second drawing module, configured to: when the display positions of the interface element types indicate that the interface element types are displayed in a column, set all blocks in a first column as text blocks, display an interface element type in each text block, set all blocks in a second column as element blocks, and draw, in each element block, an interface element corresponding to an interface element type displayed in a text block in a same row.
